(19) United States
(12) Patent Application Publication
(10) Pub. No.: US 2005/0072645 A1
(43) Pub. Date: Apr. 7, 2005

(54) Cord reel with electrical outlets

(76) Inventors: James D. Kovacik, Brecksville, OH (US); Paul S. Blanch, Broadview Heights, OH (US); Joseph J. Smith, Wooster, OH (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/678,018

(22) Filed: Oct. 2, 2003

(51) Int. Cl. H02G 11/00

(52) U.S. Cl. 191/12.2 R

(57) ABSTRACT

A manually operated cord storage reel with electrical outlets, the storage reel for storing, transporting, and dispensing an electrical cord and including a frame capable of supporting the storage reel for rotation in a vertical position or a horizontal position.

### FIELD OF THE INVENTION

The present invention relates to a storage reel and more particularly to a manually operated storage reel with for storing, transporting, and dispensing electrical cord.

### BACKGROUND OF THE INVENTION

Cord storage reels for storing and transporting electrical extension cords are known. Such reels consist basically of a spool, upon which a cord can be wound. In some cases, the spool is enclosed in a housing. Typically, a crank is connected to the spool so that the spool can be manually rotated to wind the cord thereabout. Such reels are particularly useful in industrial or commercial settings such as automobile repair shops, machine shops, carpentry shops and construction sites. The reels permit workers to readily access electrical power as needed for the operation of portable electric tools, test devices, and trouble lights at various locations remote from an existing power outlet. Such reels are also convenient to use around the house and yard, particularly for use with electrically powered outdoor appliances like hedge trimmers, electric lawn mowers, edgers, and blowers that could potentially be used hundreds of feet from an electrical outlet.

It would be desirable to produce a manually operated cord storage reel having electrical outlets wherein a frame facilitates supporting the storage reel in a vertical or horizontal position.

### SUMMARY OF THE INVENTION

Consistent and consonant with the present invention, a manually operated cord storage reel with electrical outlets wherein a frame facilitates supporting the storage reel in a vertical or horizontal position, has surprisingly been discovered.

The cord storage reel comprises a unitary frame including a generally U-shaped base portion, a handle portion, and a spool mounting axle, the base portion supporting the handle portion in spaced relation from the base portion and separately supporting the spool mounting axle in spaced relation to the base portion and the handle portion; and a spool having a rotational axis, the spool adapted to be rotatingly mounted on the spool mounting axle of the frame, wherein the spool mounting axle is sufficiently spaced from the handle portion and the base portion to rotatingly receive the spool therebetween, and wherein the frame is adapted to selectively support the reel where the axis of rotation of the reel is in a first position and where the axis of rotation is in a second position.

### BRIEF DESCRIPTION OF THE DRAWING

The above, as well as other objects, features, and advantages of the present invention will be understood from the detailed description of the preferred embodiments of the present invention with reference to the accompanying drawings, in which:

FIG. 1 is an exploded front perspective view of a cord storage reel incorporating the features of the invention;

FIG. 2 is a front perspective view showing the cord storage reel illustrated in FIG. 1 in the assembled condition; and

FIG. 3 is a rear perspective view showing the cord storage reel illustrated in FIG. 1 in the assembled condition.

### DETAILED DESCRIPTION OF THE PREFERRED EMBODIMENT

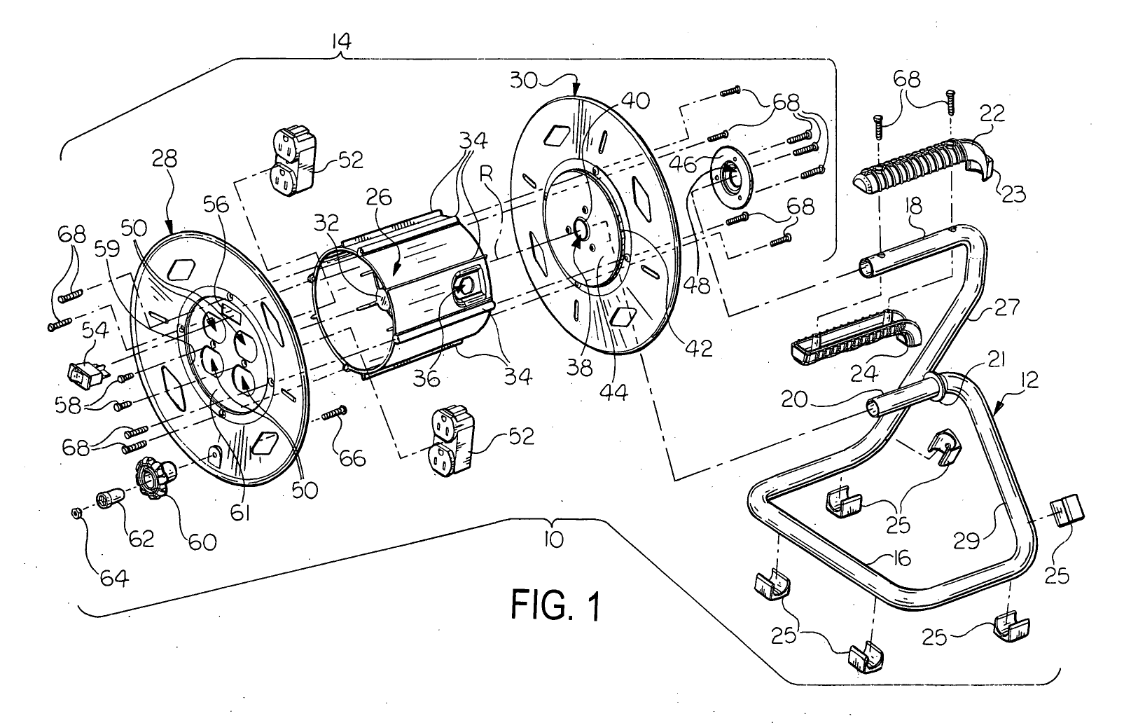

Referring now to the drawings, and particularly FIG. 1, there is shown generally at 10 a cord storage reel incorporating the features of the invention. The cord storage reel 10 includes a frame 12 and a spool 14. The frame 12 is typically a tubular structure and consists of a generally U-shaped base portion 16, a handle portion 18, and a spool mounting axle 20. The spool mounting axle 20 has a flange 21 spaced from an end thereof to militate against axial movement of the associated spool 14. The handle portion 18 is adapted to receive a top handle section 22 and a cooperating bottom handle section 24. The top handle section 22 and the bottom handle section 24 cooperate to fit around and are securely affixed on the handle portion 18 of the frame 12. A foot pad 23 is formed at one end of the top handle section 22. A plurality of foot pads 25 are disposed on the base portion 16, a leg or a cross member 27 between the base portion 16 and the handle portion 18, and a leg or a cross member 29 between the base portion 16 and the spool mounting axle 20.

The spool 14 has an axis of rotation R and includes a central hub 26, a front flange 28, and a rear flange 30. The hub 26 has a centrally disposed sleeve 32 adapted to rotatingly receive the spool mounting axle 20 of the frame 12. An annular array of ribs 34 is formed on an outer surface of the hub 26, at least some of which ribs include a threaded portion to facilitate connection of the front flange 28 and the rear flange 30 to the hub 26 to form the spool 14. An aperture 36 is formed in the hub 26 adjacent the rear flange 30 and is adapted to receive a male electrical plug (not shown) which can be connected to a female electrical plug end of an extension cord (not shown).

The rear flange 30 of the spool 14 includes a central aperture 38 adapted to be received on the spool mounting axle 20 of the frame 12 and abut the flange 21. The aperture 38 of the rear flange 30 is aligned with the sleeve 32 of the hub 26. A projecting edge 40 surrounds the aperture 38 of the rear flange 30 and extends in a direction towards the hub 26 to be received by the sleeve 32. A lip 42 surrounding a raised surface 44 is concentric with and spaced radially outwardly from the aperture 38 of the rear flange 30. The lip 42 is adapted to be received by the hub 26. A cap 46 having a central aperture 48 is adapted to be slidably received on the frame 12 and abut the flange 21 on a side opposite the rear flange 30 of the spool 14.

The front flange 28 of the spool 14 includes a plurality of central apertures 50 adapted to receive electrical outlets 52 therein. A switch and circuit breaker 54 is disposed in an aperture 56 formed adjacent the apertures 50 for the outlets 52. The outlets 52 are typically held in place using threaded fasteners 58. A lip 59 surrounding a raised surface 61 is formed in the front flange 28. The lip 59 is adapted to be received by the hub 26.

A crank handle or winding knob 60 is rotatingly disposed on the front flange 28 adjacent a peripheral edge thereof. In the embodiment shown, the knob 60 is installed over an axle 62 and connected to the front flange 28 by a nut 64 and a bolt 66. It is understood that other suitable fasteners could be used. Threaded fasteners 68 are used in the embodiment shown to connect the front flange 28 to the hub 26, the rear flange 30 to the hub 26, the cap 46 to the rear flange 30, and the top handle section 22 to the bottom handle section 24. It is understood that other fasteners could be used without departing from the scope and spirit of the invention.

To assemble the cord storage reel 10, the aperture 48 of the cap 46 is received on the handle portion 18 of the frame 12. The cap 46 is moved along the frame 12 until connected to the cap 46 using the appropriate fasteners 68. Sufficient clearance is provided between the cap 46 and the rear flange 30 to permit the cap 46 and the rear flange 30 assembly to rotate on the spool mounting axle 20 of the frame 12.

The hub 26 is connected to the rear flange 30 using the appropriate fasteners 68. The lip 42 militates against lateral movement of the hub 26 when assembled with the rear flange 30. The male electrical plug disposed in the aperture 36 formed in the hub 26 is electrically connected to the outlets 52. An electrical connection is then made between the outlets 52 and the switch and circuit breaker 54. The outlets 52 are installed in the apertures 50 and the switch is installed in the aperture 56.

The front flange 28 is connected to the hub 26 using the appropriate fasteners 68. The lip 59 militates against relative movement between the hub 26 and the front flange 28 when assembled. The knob 60 is then fastened to the front flange 28 using the axle 62, the nut 64, and the bolt 66.

The top handle section 22 and the bottom handle section 24 are aligned with and connected to surround the handle portion 18 of the frame 12. Appropriate fasteners 68 are used to join the top handle section 22 and the bottom handle section 24 with the handle portion 18. The foot pads 25 are snapped on the frame 12 to be securely held thereon.

The use of the cord storage reel 10 will now be described. Typically, the female electrical plug end of the extension cord is connected with the male electrical plug installed in the aperture 36 of the hub 26. When being stored, the extension cord is coiled onto the hub 26 of the spool 14. This is accomplished by a user gripping the knob 60 and rotating the spool 14 in the desired direction to coil the extension cord.

When it is desired to use an electrical tool or an appliance, a male electrical plug end of the extension cord is plugged into a wall outlet (not shown). The user then uses the handle portion 18 to carry the cord storage reel 10 to a desired location. While transporting the cord storage reel 10, the extension cord is caused to be spooled out or uncoiled from the spool 14. At the desired location, the user is able to plug in the tool or appliance. Electrical power can then be supplied to the tool or appliance by moving the switch and circuit breaker 54 to the on position. In the event there is a short, the switch and circuit breaker 54 will be caused to interrupt the power supply, until the short can be corrected.

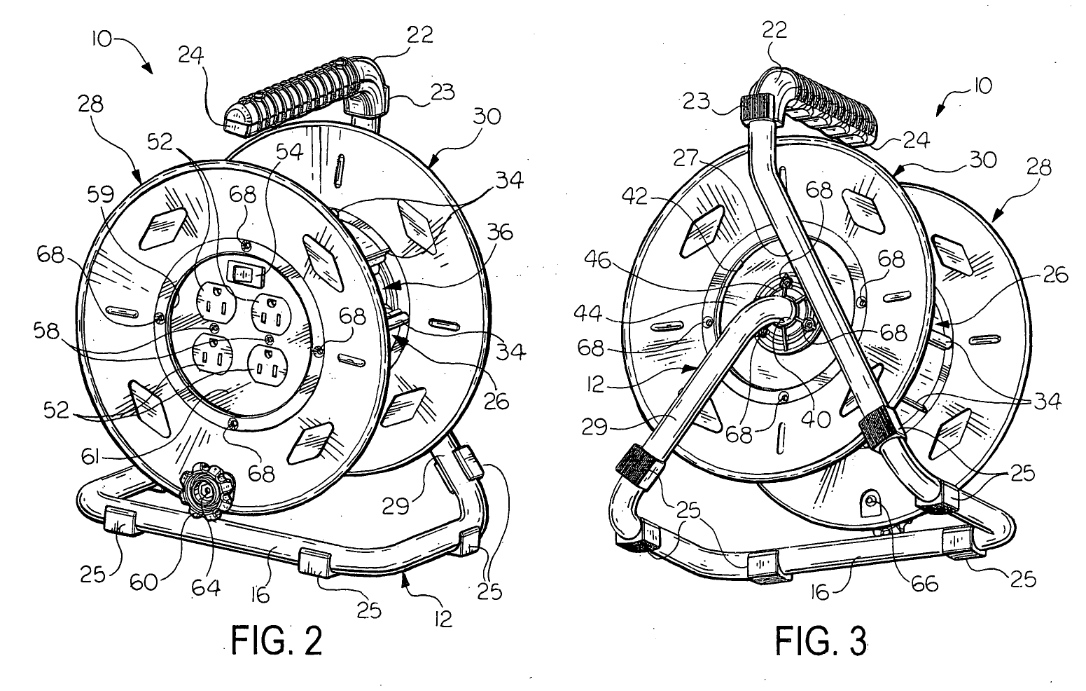

During use, the user can position the cord storage reel 10 with the axis of rotation R in a substantially horizontal position as shown in FIG. 2. Additionally, where space limitations or use requirements dictate, the cord storage reel 10 can be placed on its back or with the axis of rotation R in a substantially vertical position. With the axis of rotation R in the horizontal position, the cord storage reel 10 is supported on any horizontal planar surface by the foot pads 25 located on the base portion 16 of the frame 12. With the axis of rotation R in the vertical position, the cord storage reel 10 is supported on the horizontal support surface by the foot pads 25 located on the cross member 27 between the base portion 16 and the handle portion 18, the cross member 29 between the base portion 16 and the spool mounting axle 20, and the foot pad 23 disposed on the top handle section 22. FIG. 3 most clearly shows the back portion of the cord storage reel 10 which supports the cord storage reel 10 with the axis of rotation R in the vertical position.

Permitting the user to use the cord storage reel 10 with the axis of rotation R in the horizontal position and the vertical position provides the user with the flexibility of using the cord storage reel 10 in a variety of situations. Additionally, in the embodiment shown, the front flange 28 and the rear flange 30 are produced from metal, whereas the remaining parts of the cord storage reel 10 are produced from plastic. The metal flanges 28, 30 provide structural strength and rigidity, while the plastic portions minimize the overall weight of the cord storage reel 10. It is understood that other materials having similar properties to those mentioned above can be used without departing from the scope and spirit of the invention.

From the foregoing description, one ordinarily skilled in the art can easily ascertain the essential characteristics of this invention and, without departing from the spirit and scope thereof, can make various changes and modifications to the invention to adapt it to various usages and conditions.

1-20. (canceled)

21. A cord storage reel comprising:
a unitary frame including a generally U-shaped base portion, a handle portion and a spool mounting axle, said base portion, said handle portion and said axle being in spaced relation to one another;
a hub having opposed open ends;
a front flange attached to one end of said hub and having a raised surface received in said one end; and
a rear flange attached to another end of said hub and having a raised surface received in said another end, said hub and said front and rear flanges forming a spool rotatably mounted on said axle wherein said axle is sufficiently spaced from said handle portion and said base portion to permit rotation of said spool about an axis of rotation, said frame being adapted to selectively support said spool in at least two positions of said axis of rotation.

22. The cord storage reel according to claim 21 wherein the at least two positions are substantially vertical and substantially horizontal orientations of said axis of rotation relative to a horizontal plane.

23. The cord storage reel according to claim 21 wherein said handle portion extends substantially parallel to a plane containing said base portion.

24. The cord storage reel according to claim 21 wherein said spool mounting axle extends substantially parallel to a plane containing said base portion.

25. The cord storage reel according to claim 21 wherein said front flange and said rear flange are produced from a metal material.

26. The cord storage reel according to claim 21 wherein said frame and said hub are produced from a plastic material.

27. The cord storage reel according to claim 21 wherein said raised surface of said front flange includes at least one electrical outlet installed therein adapted to be connected with a source of electrical power.

28. The cord storage reel according to claim 27 wherein said front flange includes a switch and circuit breaker connected to said at least one electrical outlet to selectively interrupt the source of electrical power supplied to said at least one electrical outlet.

29. The cord storage reel according to claim 21 wherein said front flange includes a knob for effecting rotation of said spool on said spool mounting axle of said frame.

30. The cord storage reel according to claim 21 wherein said frame is produced from tube stock.

31. A cord storage reel comprising:
a frame including a base portion, a handle portion, and a spool mounting axle, said handle portion being connected to said base portion by a first leg and said spool mounting axle being connected to said base portion by a second leg; and
a spool rotatably mounted on said spool mounting axle for rotation about an axis of rotation, said spool including a hub and front and rear flanges, said front and rear flanges being releasably attached to opposite open ends of said hub.

32. The cord storage reel according to claim 31 wherein said hub includes a plurality of external ribs and said front and rear flanges are attached to said hub by a plurality of threaded fasteners engaging said ribs.

33. The cord storage reel according to claim 31 wherein said front and rear flanges are produced from a metal material and said frame and said hub are produced from a plastic material.

34. The cord storage reel according to claim 31 wherein said front flange includes at least one electrical outlet installed therein adapted to be connected with a source of electrical power and a switch and circuit breaker installed therein and connected to selectively interrupt the source of electrical power supplied to said at least one electrical outlet.

35. The cord storage reel according to claim 31 wherein said front and rear flanges each include a central raised surface received in an associated one of said open ends of said hub.

36. A cord storage reel comprising:
a frame including a base portion, a handle portion, and a spool mounting axle, said handle portion being connected to said base portion by a first leg and said spool mounting axle being connected to said base portion by a second leg;
a plurality of foot pads disposed on said base portion and said first and second legs;
a spool rotatably mounted on said spool mounting axle for rotation about an axis of rotation, said spool including a hub and front and rear flanges, said front and rear flanges being releasably attached to opposite open ends of said hub; and
at least one double electrical outlet mounted on said front flange for connection to a source of electrical power.

37. The cord storage reel according to claim 36 wherein said front and rear flanges each include a central raised surface received in an associated one of said open ends of said hub.

38. The cord storage reel according to claim 36 wherein said hub includes a plurality of external ribs and said front and rear flanges are attached to said hub by a plurality of threaded fasteners engaging opposite ends of said ribs.
